(19) United States
(12) Patent Application Publication
(10) Pub. No.: US 2020/0372249 A1
(43) Pub. Date: Nov. 26, 2020

(54) Multi Receipt Detection

(71) Applicants: Canon Information and Imaging Solutions, Inc., Melville, NY (US); Canon U.S.A., Inc., Melville, NY (US)

(72) Inventors: Ryoji Iwamura, Port Washington, NY (US); Shingo Murata, Mineola, NY (US); Kazuaki Fujita, Tokyo (JP); Kenji Takahama, Tokyo (JP)

(21) Appl. No.: 16/881,728

(22) Filed: May 22, 2020

Related U.S. Application Data
(60) Provisional application No. 62/852,773, filed on May 24, 2019.

(51) Int. Cl. G06K 9/00; G06K 9/20; G06Q 10/10; G06Q 40/00

(52) U.S. Cl. CPC G06K 9/00469; G06K 9/2072; G06K 2209/01; G06Q 10/10; G06Q 40/12; G06K 9/00463

(57) ABSTRACT

An information processing method and apparatus is provided for obtaining a captured image; detecting a character region from the captured image; performing association processing between expense type information specified from each of one or more receipts which are identified by using a detection result of the character region from the captured image and expense amount information specified from each of the one or more receipts in the captured image; and outputting an expense report obtained based on the association processing between the merchant information of each of one or more receipts and the one or more pieces of expense amount information of each of the one or more receipts.

### CROSS REFERENCE TO RELATED APPLICATIONS

This nonprovisional patent application claims the benefit of priority from U.S. Provisional Patent Application Ser. No. 62/852,773 filed on May 24, 2019, the entirety of which is incorporated herein by reference.

### BACKGROUND

### Field

The present disclosure relates generally to image processing and analysis of a captured images.

### Description of Related Art

Applications exist that enable image capturing of a physical document. An example of this type of application is a receipt capture application that captures an image corresponding to a physical receipt such as one received when a purchase has been made by a user. It is desirable for users to be able to capture and analyze physical receipts in order to track costs and expenses attributable to the user. A drawback associated with these receipt capture applications is that, often times, the applications expects only a single receipt to analyze when you capture the receipt image. In these existing systems, when having multiple receipts to be captured and analyzed, they can be captured one by one to analyze them one by one. There is difficulty in differentiating between images that contain only a single receipt and multiple receipts.

### SUMMARY

In one embodiment, an information processing method and apparatus is provided for obtaining a captured image; detecting a character region from the captured image; performing association processing between expense type information specified from each of one or more receipts which are identified by using a detection result of the character region from the captured image and expense amount information specified from each of the one or more receipts in the captured image; and outputting an expense report obtained based on the association processing between the merchant information of each of one or more receipts and the one or more pieces of expense amount information of each of the one or more receipts.

In another embodiment, an information processing method and apparatus is provided for obtaining a captured image; detecting an object from the captured image; specifying a receipt region by using a detection result of the object; performing association processing between expense type information that is specified from the receipt region that is identified based on the detection result of the object and expense amount information that is specified from the receipt region; and outputting an expense report obtained based on the association processing between the expense type that is specified from the receipt region in the captured image and the expense amount information that is specified from the receipt region in the captured image.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIGS. 1A & 1B are flow diagram detailing an image processing and analysis algorithm.

FIG. 2A & 2B represent an exemplary image captured by an image capture device and processing performed thereon.

FIG. 3 illustrates exemplary image processing performed on a captured image.

FIG. 4 illustrates exemplary image processing performed on a captured image.

FIG. 5 illustrates exemplary image processing performed on a captured image.

FIG. 6 illustrates an exemplary result of the image processing performed on the captured image.

FIG. 7 represents an exemplary image captured by an image capture device.

FIG. 8 illustrates exemplary image processing performed on a captured image.

FIGS. 9A-9D illustrates exemplary image processing performed on a captured image and result of the image processing performed on the captured image.

FIG. 10 is a block diagram detailing hardware for performing the image processing and analysis algorithm.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

There is a need to provide a system and method that improves usability and productivity by being able to identify and distinguish, from a captured image, whether the image includes one or more target object on which image processing can be performed. The application according to the present disclosure resolves a problem of identifying and distinguishing between two different objects of a same type in a same image when the background against which the image capture is performed is substantially similar to a color of the object. The application further advantageously can distinguish when an image apparently contains two different target object but really only includes a single target object. Based on the advantageous differentiation, the application improves the reliability and accuracy for any data extraction processing to be performed on the target object(s) in the captured image.

In an exemplary embodiment, the one or more target objects are receipts that represent a transaction between individuals. An application according to the present disclosure is able to capture multiple receipts in a single image capture operation and automatically process each of the multiple receipts captured in a single image capture operation on an individual basis. The application executing on computing device enables the computing device to capture multiple receipts and identify, within the single captured image, each receipt from the one image and process them properly as different receipt data items. The application advantageously differentiates receipts from a surface on which they rest prior to image capture. This is particularly advantageous when the surface on which image capture is performed has a strong color similarity with the color of the paper of the receipts. For example, an object may be a receipt having a paper color that is white and the background color of the table where receipts are placed is also white or very close thereto, there is a difficulty in identifying which data belong to which receipt in the captured image. The application advantageously identifies each receipt as different ones and prevents further image processing operation, such as data extraction (e.g. object character recognition (OCR) processing), from incorrectly attributing data from one receipt to another. Further, this application also properly identifies when a capture image which appears to include more than one receipt, actually only includes a single receipt. The applications and the advantageous provided thereby can be achieved based on the algorithm and figures discussed hereinbelow.

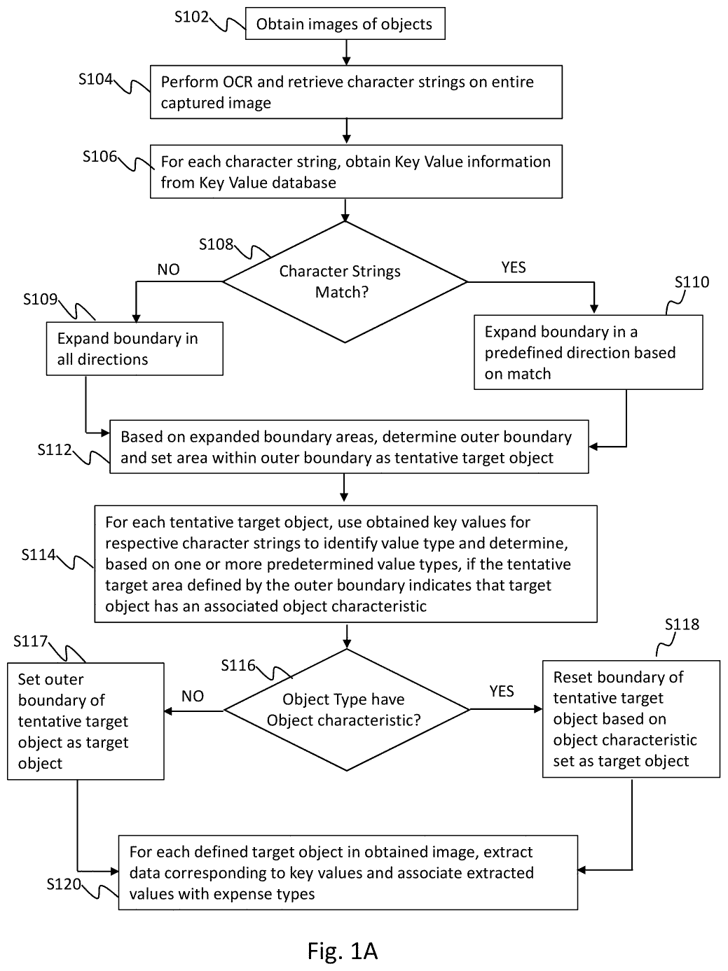

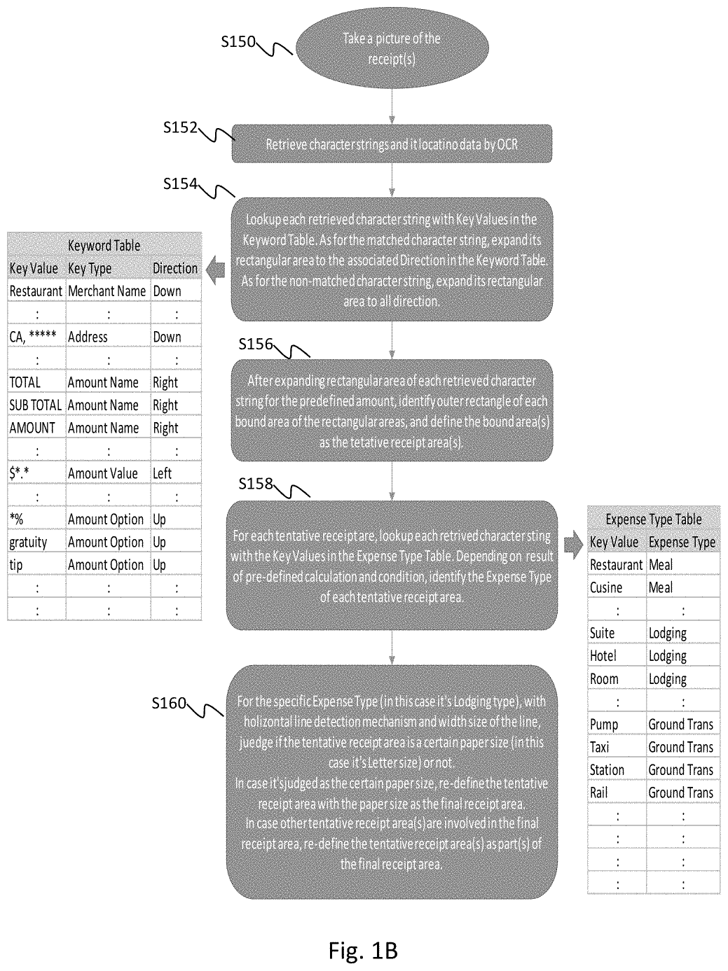

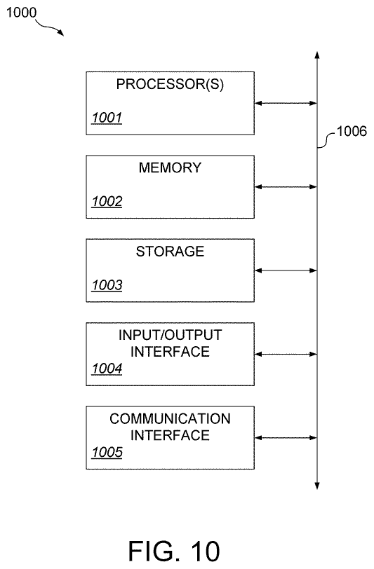

FIG. 1 illustrates an exemplary image processing and analysis algorithm executed by an information processing apparatus. The algorithm is embodied as a set of instructions stored in one or more non-transitory memory devices that are executable by one or more processors (e.g. CPU) to perform the functions that are described in the present disclosure. In one embodiment information processing apparatus such as a computing device is provided. A computing device includes but is not limited to a personal computer or server stores the instructions which, when executed, configure the one or more processors to perform the described functions. In another embodiment, the device on which the algorithm executes is a portable computing device such as a mobile phone, smartphone, tablet or the like. Further description of exemplary hardware that is responsible for the functionality described herein can be found in FIG. 10 which is discussed in greater detail below.

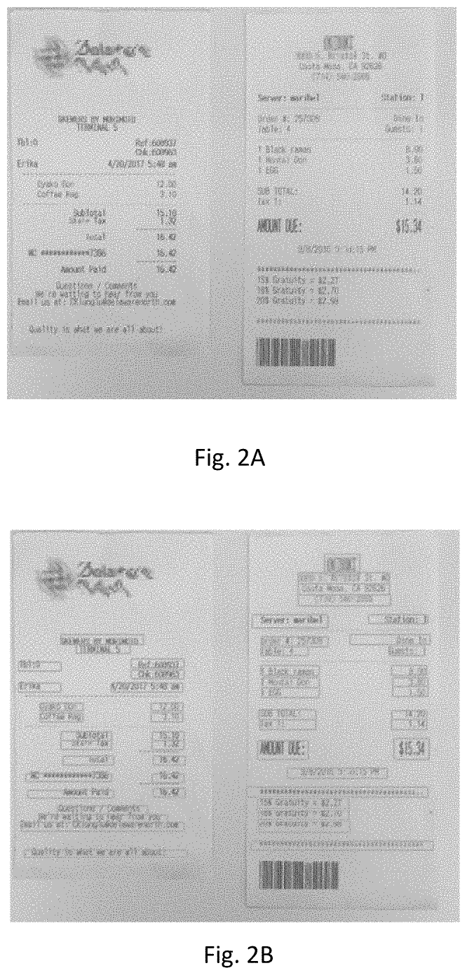

The following description of the functionality of image processing and analysis application according to the present disclosure will occur using the instructional steps illustrated in FIG. 1 while making reference to exemplary images and image processing operations performed on captured images illustrated in FIGS. 2-9.

At step S102, images of one or more objects are obtained. The images are obtained using an image capture device such as a camera of a mobile phone. In another embodiment, the images may be obtained via file transfer process whereby the computing device acquires one or more images from an external source. This may include, for example, a cloud storage apparatus whereby a user can selectively access and download one or more images on which the processing disclosed herein may be performed. In another embodiment, the images may be attached to an electronic mail message and extracted by the application therefrom in order to perform the processing described herein.

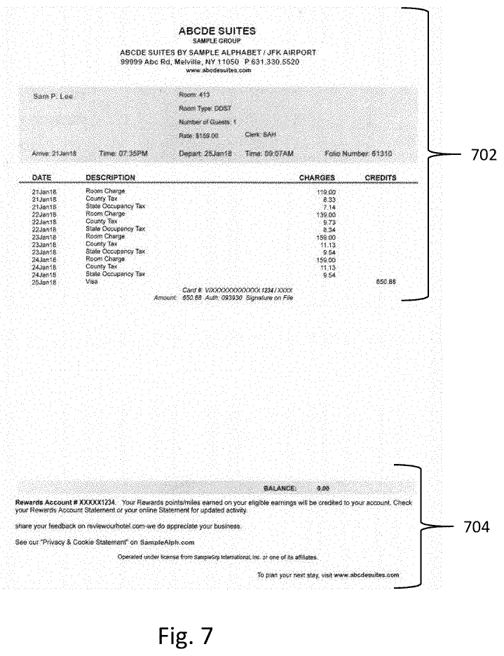

The images include at least one object that is resting on a surface and includes one or more data items that can identified and extracted for storage in a data store (e.g. database). An example of a type of image obtained at S102 is illustrated in FIG. 2 and FIG. 7. In FIG. 2, the obtained image represents two objects each having a similar object color with one or more data items on each object that may be extracted. The background of the image in FIG. 2 represents a surface atop which the objects sit. The color of the background surface is substantially similar to the color of each of the two objects in the image. In conventional image processing, it is difficult to identify the boundaries of each object in the image due to the similarity in color between the objects and the background. In the example shown in FIG. 2A, the objects represent physical receipts having text printed thereon. The fact that the objects described herein are receipts is exemplary and any printed document may be processed in accordance with the described algorithm. The obtained image can include multiple receipts where (a) the color of receipts and background color could be different enough to allow for each receipt in the image to be identified or (b) could be too close in color to identify each receipt. While the algorithm described herein can adopted for both cases (a) and (b), the algorithm is particularly effective for case (b).

At step S104, the obtained images are processed using optical character recognition processing module/process to retrieve character strings and location data associated with each retrieved character string. The results of the OCR in general will include all retrieved character strings and its location data within the image. The OCR processing performed may be able to recognize any type of alphanumeric character including, letter, numbers, special characters and can recognize characters of one or more language. As long as the result contains all retrieved character strings and its location data, the OCR module/process can be replaced with any general OCR module/process, but the quality of result will vary depending on the result of the OCR module/process. The results of the OCR processing in S104 is illustrated in FIG. 2B which visualizes the results of the OCR processing. The result of the OCR processing creates character string fields that surround each set of character strings recognized during the OCR processing. Each character string field includes a range of characters recognized by the OCR processing performed. These character string fields are illustrated in FIG. 2B by the individual boxes positioned around each line of text within the image. While it is readily apparent to the human eye that there are two objects present, the determination that there are two objects is not automatically apparent to the computing device without the following procedures being performed. Additionally, the character string fields contain location information associated with each character string recognized by the OCR process such that where each character strings field is located in the picture based on the location data of each one as the OCR results. In another embodiment, the character string region is detected based on a user operation that defines a region within the image.

After OCR processing at step S104 is complete, a lookup process is performed in order to obtain information about the plurality of character strings that were retrieved in order to determine information about the objects captured in the image. This is performed using a first database that includes Keyword information which will aid the determination as to how many objects are present within the image. The Keyword database includes a plurality of entries that represent different types of character strings that may be recognized during the OCR process. Further, each entry in the Keyword database includes direction data associated therewith. The direction data is used by the algorithm as described later in order to expand the respective character string field to further define the boundary of the target object. The Keywords are object-specific and are used by the algorithm to set an outer boundary for one or more objects within the image as discussed below. In the example used herein, the objects sought to be recognized are receipts. As such, the Keyword database includes a plurality of entries including types of characters/fields that are commonly found on receipts and are indicated as “Key Types” within the database. The Key Type represents the type of field that a particular character string recognized by OCR represents. The pre-stored set of key type information include entries such as Merchant Name, Address, Amount Name, Amount Value, Amount Option, etc. The contents of the Keyword database as described herein is for purpose of example only and used to illustrate the principle of operation and the database preferably includes a plurality of different keyword types and associated direction data which will help improve the boundary defining processing discussed below.

An exemplary Keyword database and its contents is illustrated in Table 1 below.

TABLE 1
Keyword Table

| Key Value | Key Type | Direction |
|---|---|---|
| Restaurant | Merchant Name | Down |
| . | . | . |
| . | . | . |
| . | . | . |
| CA, ***** | Address | Down |
| . | . | . |
| . | . | . |
| . | . | . |
| TOTAL | Amount Name | Right |
| SUB TOTAL | Amount Name | Right |
| AMOUNT | Amount Name | Right |
| . | . | . |
| . | . | . |
| . | . | . |
| $*.* | Amount Value | Left |
| . | . | . |
| . | . | . |
| . | . | . |
| *% | Amount Option | Up |
| gratuity | Amount Option | Up |
| tip | Amount Option | Up |
| . | . | . |
| . | . | . |
| . | . | . |
| . | . | . |
| . | . | . |
| . | . | . |

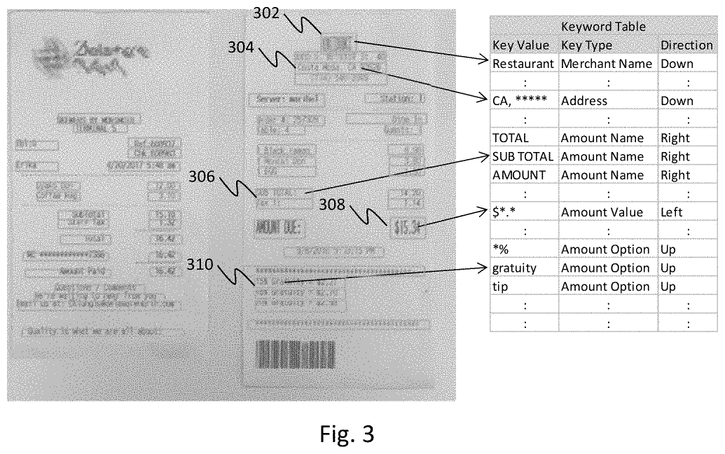

Step S108-S110 represent the matching and expansion processing performed on the objects within the image. S108 makes use of the recognized characters in each character string field illustrated in FIG. 2B and determines whether the recognized character string includes one or more characters that correspond to a Key Type contained in the Table. Thus, in S108 a mapping of recognized character strings to Key Types is performed. This processing is illustrated in FIG. 3.

In FIG. 3, the matching process occurs using the data in Table 1 which represents the pre-defined keyword list. Key Value is the keyword to search in the OCR result. The Key Type is the category of the Key Value and the Direction is the direction for image expansion processing of each range (e.g. character string field) for Key Value. Depending on the Key Type, the location of the associated Key Value in the receipt is pre-defined. For example, there is tendency in general that the Marchant Name is printed on upper location within the receipt, the Amount Name is printed on left side within the receipt, and the Amount Value is printed on right side within the receipt. Depending on the pre-defined location for each Key Type, the Direction data is pre-defined as the direction for image expansion processing that supposed to be directing toward center of a receipt. For example, the Merchant Name supposed to be printed on upper location of the receipt, thus the Direction of the Marchant Name (“Restaurant” in this case) is set as “Down”. The Amount Name is expected to be printed on left side of the receipt, thus the Direction of the Amount Name (“SUB TOTAL” in this case) is set as “Right”.

The matching operation of S108 may employ one or more pre-defined matching conditions such as full-match or partial match. In the case of a partial match condition being used, further pre-configured sets of matching conditions may be used. For example, a matching condition indicating that characters match the Key Type of “Merchant Name” should be less than 10 alphabetical characters and less than 3 numerical characters. This is merely exemplary and any condition may be used to define a successful match.

With respect to FIG. 3, an exemplary matching process can be visualized. The plurality of character string fields in FIG. 3 are those recognized and shown in FIG. 2. The matching process takes characters from each recognized character field and the location of the particular field within the object to determine if one or more characters in the particular character field match a key type. For example, character field 302 includes a plurality of alphanumeric characters and includes location data that indicates that the field is at a top section of the image. This indicates that the characters in field 302 represent a merchant name Key Type and the direction of expansion towards a center of the object is “down”. In character field 304, one or more characters have a predefined format such as “XX, *****”. This indicates that the characters in this field are part of an address. As shown herein, the recognized characters are “CA, 32628” which represent a state and zip code and, based on the location data and expected positioning of the particular Key Type, the direction data indicates expansion towards a center of the object is in the down direction.

For character field 306, one or more characters are recognized as including the word “SUB TOTAL”. When compared to the keyword table, it is determined that character field 306 corresponds to an Amount Name and, based on the location of character field 306 and expected location within the object, the direction data used for expansion towards a center of the object is rightward direction. It should be noted that, in Table 1, there are multiple entries that include the characters “TOTAL” and this is an example of a type of robustness that is preferred for the Keyword database which includes not only a plurality of Key Types that are object-specific but also a plurality of Key Values that can signify the same Key Type which allows the algorithm to more accurately process a same type of object but which may include the same elements represented in different ways. In the case of a receipt, the relevant characters may be “TOTAL” but this could appear in that way or, as in the case shown in FIG. 3 as “SUB TOTAL” or using a an analogous term such as “AMOUNT” all of which still indicate that the Key Type is the Amount Name.

For character field 308, the recognized characters in the character string include a predetermined special character “$” and also include a defined format of “$ *.*” where the * represent at least one numerical value. This indicates the character field 310 corresponds to an Amount Value which, based on the location of the particular character string field within the object and an expected position of the Key Type within the object has direction data that directs expansion towards a center of the object be in the leftward direction

For character field 310, the characters therein include the word “GRATUITY” which indicate that the character field corresponds to the Key Type of Amount Option and that, based on the position of character field 310 and the expected position within the object, that the direction data that directs expansion towards a center of the object is an upward direction.

The reference and discussion of the matching of characters in fields 302-310 is meant to illustrate operation only. During operation each of the respective character fields in FIG. 3, whether denoted by a reference numeral or not, would be analyzed and compared to values in Table 1 to see if there is particular direction data which is used to direct expansion towards a center of the object such that an outer boundary for that object can be determined. As will be discussed below, where characters in a particular character field do not match a Key Type in Table 1, the expansion direction occurs in all directions around the particular character string field.

If the result of the character match determination in S108 is negative, the result indicates that the characters in a particular character string field do not correspond to the predefined Key Types. In this instance, the expansion processing to be performed expands the boundary of the field in all directions (up, down, left, right) as indicated in S109. In the result of the character match determination in S108 is positive indicating that characters in the particular character field match the Key Type, the expansion processing is performed using the direction data associated with the direction data associated with the Key Type.

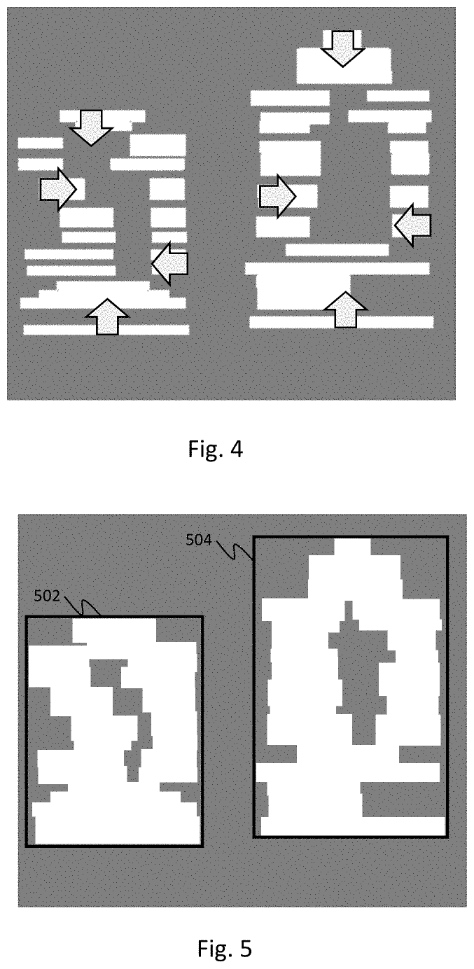

Despite S109 and S110 being illustrated as separate steps, they are both part of the expansion processing performed in order to detect how many target objects are present within a particular image. Expansion processing will now be described with respect to FIGS. 4-6.

In order to perform expansion processing, a binary map of the obtained image is generated where a background of the image is a first color and pixel areas within each of the recognized character fields are a second different color. This is illustrated in FIG. 4 which shows the background of the obtained image in gray and areas of each recognized character string fields as blocks of white pixels. This color scheme is exemplary and used to more clearly represent the processing. However, in operation, the background color of the image is more appropriately black and the map of recognized character string fields are blocks of white overlaid on the black background.

Referring now to FIG. 4, for each character string field that was analyzed in S108 where the OCR result was used to check each character string if it matches with any keyword (Key Value), expansion processing is performed. For the character string matches any keyword (Key Value), expand the range of character string (white rectangle range representing the particular character string field) using the direction data associated with the keyword until a pre-configured expansion condition is reached. For the character string that do not match any keyword, expand the range of character string in all directions until the pre-configured expansion condition is met. The pre-configured expansion condition represents an adjusted value of pixels within the image such that certain number of ranges of character strings to be overlapped which results in building a certain number of groups of connected fields. For example, the pre-configured expansion condition may be a ratio decided based on the height and width of each range of retrieved character string in the character string fields. The pre-configured expansion condition can also include a number of groups to be formed by expansion. For example, the number of groups may be one or more groups. This processing is illustrated in FIGS. 4 and 5 whereby in FIG. 4, the matches for the character string fields have been determined and the arrows indicate the direction data for use in expanding the character fields in order to build the groups as shown in FIG. 5. The fields in FIG. 4 having the arrows illustrate the direction of expansion of the particular field performed until the pre-defined expansion condition is met. The result in FIG. 5 shows expansion is completed by combining each of the individual character string fields into a single group. This processing causes the image generated in FIG. 4 to be updated as shown in FIG. 5.

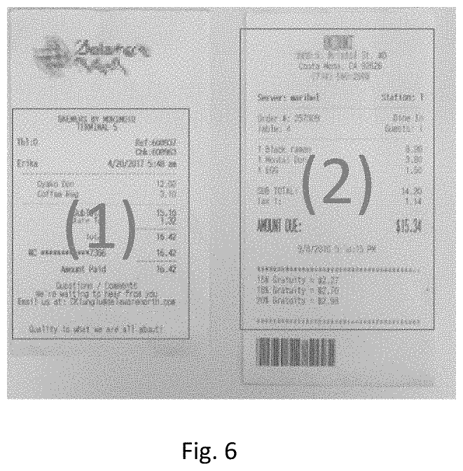

Based on the number of groups contained in the updated image of FIG. 5, the algorithm determines, in step S112, an outer boundary for each detected group and sets the area within the determined outer boundary as a tentative target object to be recognized. In the example herein, the algorithm sets a first outer boundary 502 that surrounds a first group of expanded character string fields as a first tentative target object and a second outer boundary 504 that surrounds a second group of expanded character string fields as a second tentative target object. Defining the outer boundary for each tentative target object is bounding box processing which expands outward a predetermined number of pixels from an outer most edge of the object to be surrounded. The first outer boundary 502 and second outer boundary 504 in FIG. 5 indicate that the OCR processing performed indicates that data items within these boundaries are associated with the object being recognized. In this case, the boundaries suggest that data within is valuable and can be extracted depending on need. Based on the boundary formation around the tentative target objects, the algorithm, as shown in FIG. 6, sets a first tentative target object (1) and a second tentative target object (2).

In step S114, for each tentative target object (1) and (2) in FIG. 6, the Key Values determined from S108 are used to query an object type database. In this example, where the target objects are receipts, the object type database includes entries that are used to identify the type of receipt and type of expense associated with the receipt. An example of the object type database is shown in Table 2 which is an Expense Type Table that can be used to determine and confirm that the tentative target object should be set as the actual target object from which data extraction should be performed.

TABLE 2
Expense Type Table

| Key Value | Expense Type | Characteristic |
|---|---|---|
| Restaurant | Meal | No |
| Cuisine | Meal | No |
| . | . | . |
| . | . | . |
| . | . | . |
| Suite | Lodging | Yes, size |
| Hotel | Lodging | Yes, size |
| Room | Lodging | Yes, size |
| . | . | . |
| . | . | . |
| . | . | . |
| Pump | Ground Trans | No |
| Taxi | Ground Trans | No |
| Station | Ground Trans | No |
| Rail | Ground Trans | No |
| . | . | . |
| . | . | . |
| . | . | . |

When the Key Values determined in S108 are used to determine the Expense Type, the determined expense type may have an associated predefined object characteristic. In one embodiment, the predefined object characteristic defines an expected size of the target object based on the type of object. For example, if the Expense Type is determined to be Lodging, the predefined characteristic size may indicate a page size of “Letter Size” or “dimension=8″×11”. In another embodiment, the object characteristic may indicate a predetermined range of pixels within the image that are of a single color (e.g. white space). These object characteristics are described for purposes of example only and any detectable feature within an image may be associated with a specific object type in order to determine and set whether a tentative target object is an actual target object from which data can be extracted.

In S116, it is determined whether the particular object type includes a particular object characteristic. For example, using Table 2, the Key Values determined in S108 indicate that the Expense Type for the tentative target object (1) and (2) are “Meals” and that there are no object characteristics associated therewith. Thus, the determination in S116 is negative and the algorithm sets the first tentative target object (1) and second tentative target object (2) as Target Object 1 and Target Object 2 which indicates that the obtained image includes two objects each having discrete information contained therein. Once the number of target objects in the obtained image are set, data corresponding to the Key Values are extracted and associated with the type of expenses. The extracted information may then be stored in a report such as an expense report. S120 further includes performing association processing between expense type information specified from each of one or more receipts which are identified by using a detection result of the character region from the captured image and expense amount information specified from each of the one or more receipts in the captured image and outputting an expense report obtained based on the association processing between the merchant information of each of one or more receipts and the one or more pieces of expense amount information of each of the one or more receipts.

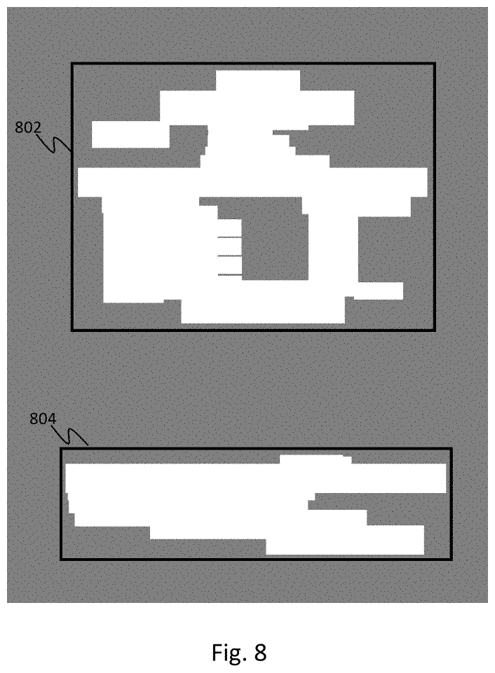

In order to illustrate the result of a positive determination in step S116, a second different image, as shown in FIG. 7, will be referenced. The image of FIG. 7 illustrates a single object which may be incorrectly identified as two different object based on the structure of the object and because of the type of object it is. For example, in case where an object has a certain size of blank area, the process may identify multiple bounding boxes in the receipt and it would cause a wrong judgement being made to identify the receipt area candidate(s). With the process above, the object of FIG. 7 which represents a hotel receipt will result in 2 bounding boxes being formed meaning that the process would make wrong judgement to understand that there are 2 receipts in the captured image area (black background area), without the additional process described as follows However, based on the determinations made herein, this object will properly be defined as a single object. The image obtained (S102) of FIG. 7 includes a first section 702 and a second section 704. Without the object characteristic processing that follows, the algorithm described above in S102-S114 may incorrectly determine that the image contains two target objects. As such, operational steps S104-S112 are performed as discussed above with respect to FIGS. 2-6. The result of this processing is shown in FIG. 8 where the first section 702 in FIG. 7 is set as the first tentative target object 802 and the second section 704 in FIG. 7 is set as the second tentative target object 804 in FIG. 8. Without the processing performed in the path defined by S114, S116 and S118 (described below), a hotel receipt will result in 2 bounding boxes being formed meaning that the process would make the wrong judgement to understand that there are 2 receipts in the captured image area (black background area).

With respect to FIGS. 7 and 8, step S114 is performed for each bounding box 802 and 804 in FIG. 8 to lookup each obtained character string with the Key Values in the Expense Type list Table 2 to identify the Expense Type for each bounding box. In this case the upper bounding box 802 will be judged as “Lodging” type receipt, and the lower bounding box will be judged as “Other Expense” type receipt. A bounding box will be judged as other when no retrieved character strings match any defined Expense Type in the Expense Type Table. However, because bounding box 802 corresponding to the first tentative target object includes one or more character strings indicating that the Expense Type is “Lodging” and that the determined Expense Type includes a set object characteristic, further processing is performed to set the target object based on the object characteristic and the type of Expense. Because the Expense Type of “Lodging” has a defined object characteristic of size, uses this characteristic to set the boundary of the target object in S118. The object characteristic may also include a value associated therewith which is used by the bounding box processing to re-define the determined bounding boxes as needed. In this example, the object characteristic is “size” and the defined value may be, for example “Letter Size” or “8.5×11” representing an expected size of the object. Thus, in S118, because the first tentative target object 802 in FIG. 8 is determined to be an Expense Type of “Lodging” and that this type of expense includes a receipt of predetermined size, the bounding box needs to be reset or re-defined.

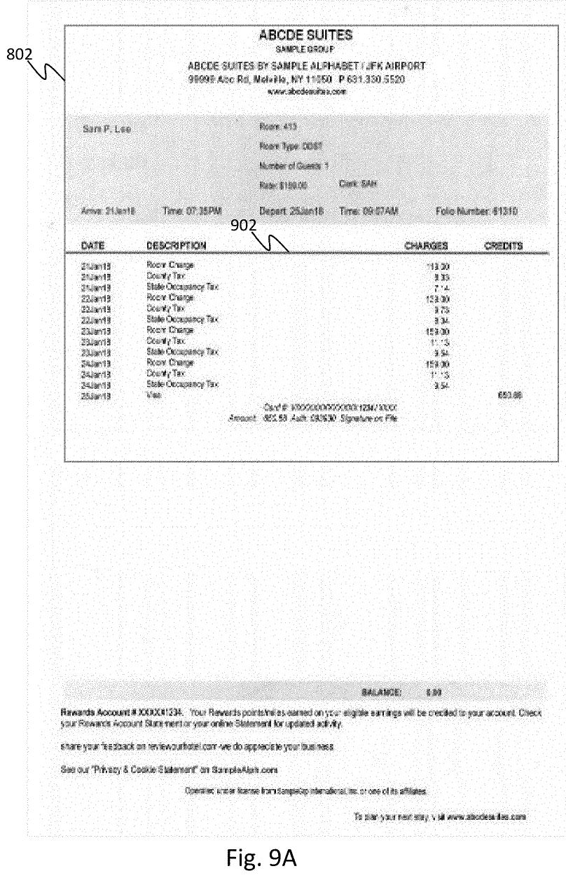

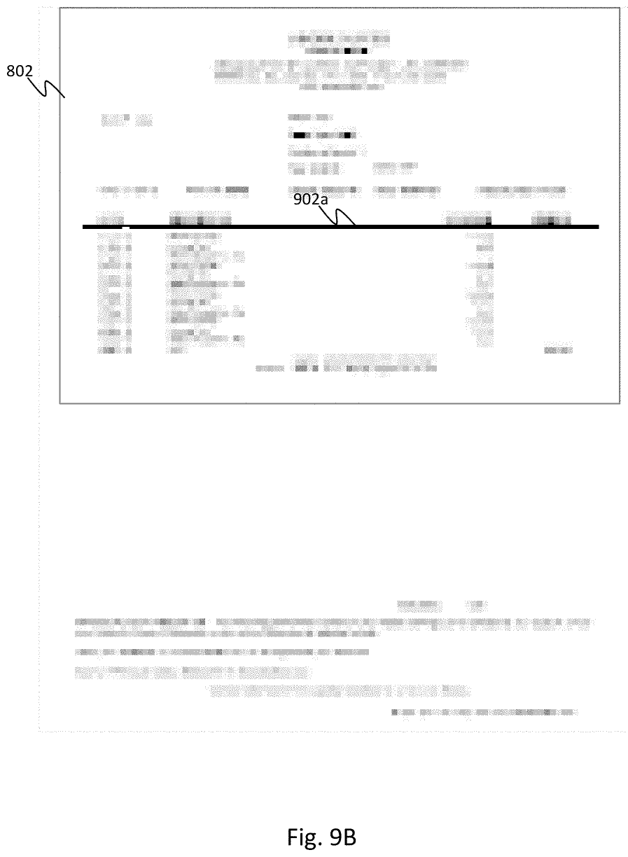

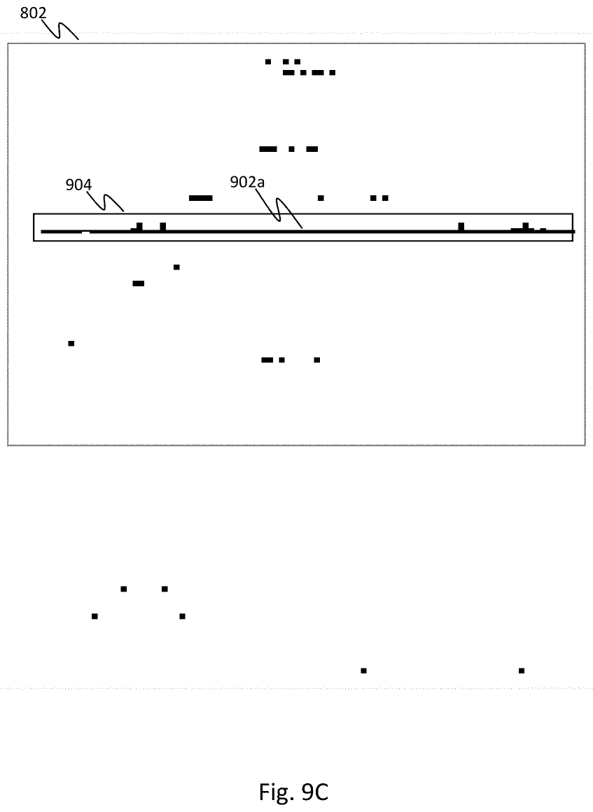

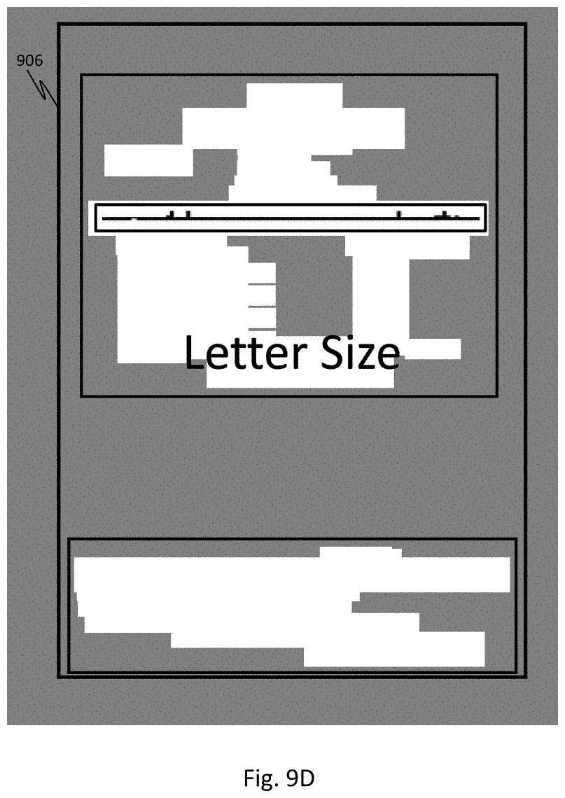

This processing is illustrated in FIGS. 9A-9C and the resulting redefinition of the bounding box of the target object is shown in FIG. 9D. To determine the correct size of the new bounding box to be set, the algorithm analyzes the obtained image for one or more predetermined image features and, if detected, enhances the detected image feature and determines if the feature meets a predetermined condition. If the condition is met, a new size of the bounding box is defined. In one embodiment, the predetermined feature known to be associated with the Expense Type of Lodging is horizontal line of pixels having the same pixel color such as a line. This feature is denoted by 902 in FIG. 9A. Upon detecting this feature within the area of the first tentative target object 802, the algorithm enhances the feature 902a within the image as shown in FIG. 9B. In the case shown here where the feature is a line, the enhancement processing expands the height of the line to make the line more pronounced so that it can be used to decide if the feature indicates that boundary target object should be redefined from 802 and 804 in FIG. 8 to a single bounding box 906 as shown in FIG. 9D. Once the feature has been enhanced, a check to see if the enhanced features meets a predetermined condition is met. The algorithm generates a measurement box 904 around the enhanced feature 902a to determine if a length of the enhanced feature is equal to a greater than a threshold length. If so, the algorithm determines that, based on the Expense Type of Lodging and the presence of one or more features, the expected size of the object is different than the size of the bounding boxes for one or both of the tentative target objects. Then, in S118, the size of the bounding box in the obtained image is reset to equal the expected size of the object. In this case, the expected size of the object is “Letter Size” and a new, redefined bounding box 906 is set so that extraction of data values as set forth in S120 can occur.

Exemplary operation described above is further summarized when looking back at FIG. 1B. Therein, in S150, an image capture device captures an image including at least one target object on which data extraction is to be performed. In S152, one or more character strings and location data of the retrieved character strings are obtained. In S154, a lookup operation on each retrieved character string with Key Values in the Keyword Table in FIG. 1B. For any character string matched in the lookup operation, an area surround the character string is expanded in a direction defined in the Key Word Table. For character strings where no match is found, an area of that particular character string is expanded in all directions. The expansion in S154 occurs for predefined expansion amount representing pixels surrounding the respective retrieved character string to form at least one group. In S156, after expansion, an outer boundary is formed around all of the expanded string fields forming the at least one group. The outer boundary surrounding the group is set as the tentative receipt area. In S158, for each tentative receipt area, another lookup operation is performed in an Expense Type Table to look up each character string with the Key Values. Depending on the result pre-determined calculation and condition, the Expense Type of each tentative receipt area is determined. Then, in S160, For the specific Expense Type, when the condition is present, such as a horizontal line across the image, horizontal line detection processing is performed and the width size of the line is determined in order to judge if the tentative receipt area is a certain paper size. If the line processing indicates that the tentative receipt area is the certain paper size, the tentative receipt area is redefined as equal to the paper size. In S160, if the Expense Type is not a predetermined Expense Type and a feature (e.g. horizontal line) is not present, the tentative receipt area is set as final and the number of receipts equal to the number of tentative receipts is set as final. Thus, in one embodiment, the application described above identifies each of one or more receipts within a captured image based on positions and types of each character string detected from the captured image, and create an expense report according to the result of the identification. In another embodiment, identify a receipt region for one receipt based on a length of a line detected from a captured image, and create an expense report based on information of the identified receipt region.

FIG. 10 above illustrates the hardware components of an exemplary computing system that is configured to execute the recognition algorithm discussed above. The term computing device (or computing system) as used herein includes but is not limited to a hardware device that may include one or more software modules, one or more hardware modules, one or more firmware modules, or combinations thereof, that work together to perform operations on electronic data. The physical layout of the modules may vary. A computing device may include multiple computing devices coupled via a network. A computing device may include a single computing device where internal modules (such as a memory and processor) work together to perform operations on electronic data. Also, the term resource as used herein includes but is not limited to an object that can be processed at a computing device. A resource can be a portion of executable instructions or data.

In some embodiments, the computing device 1000 performs one or more steps of one or more methods described or illustrated herein. In some embodiments, the computing device 1000 provides functionality described or illustrated herein. In some embodiments, software running on the computing device 1000 performs one or more steps of one or more methods described or illustrated herein or provides functionality described or illustrated herein. Some embodiments include one or more portions of the computing device 1000.

The computing device 1000 includes one or more processor(s) 1001, memory 1002, storage 1003, an input/output (I/O) interface 1004, a communication interface 1005, and a bus 1006. The computing device 1000 may take any suitable physical form. For example, and not by way of limitation, the computing device 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a smartphone, a mobile telephone, PDA, a computing device, a tablet computer system, or a combination of two or more of these.

The processor(s) 1001 include hardware for executing instructions, such as those making up a computer program. The processor(s) 1001 may retrieve the instructions from the memory 1002, the storage 1003, an internal register, or an internal cache. The processor(s) 1001 then decode and execute the instructions. Then, the processor(s) 1001 write one or more results to the memory 1002, the storage 1003, the internal register, or the internal cache. The processor(s) 1001 may provide the processing capability to execute the operating system, programs, user and application interfaces, and any other functions of the computing device 1000.

The processor(s) 1001 may include a central processing unit (CPU), one or more general-purpose microprocessor(s), application-specific microprocessor(s), and/or special purpose microprocessor(s), or some combination of such processing components. The processor(s) 1001 may include one or more graphics processors, video processors, audio processors and/or related chip sets.

In some embodiments, the memory 1002 includes main memory for storing instructions for the processor(s) 1001 to execute or data for the processor(s) 1001 to operate on. By way of example, the computing device 1000 may load instructions from the storage 1003 or another source to the memory 1002. During or after execution of the instructions, the processor(s) 1001 may write one or more results (which may be intermediate or final results) to the memory 1002. One or more memory buses (which may each include an address bus and a data bus) may couple the processor(s) 1001 to the memory 1002. One or more memory management units (MMUs) may reside between the processor(s) 1001 and the memory 1002 and facilitate accesses to the memory 1002 requested by the processor(s) 1001. The memory 1002 may include one or more memories. The memory 1002 may be random access memory (RAM).

The storage 1003 stores data and/or instructions. As an example and not by way of limitation, the storage 1003 may include a hard disk drive, a floppy disk drive, flash memory, an optical disc, a magneto-optical disc, magnetic tape, or a Universal Serial Bus (USB) drive or a combination of two or more of these. In some embodiments, the storage 1003 is a removable medium. In some embodiments, the storage 1003 is a fixed medium. In some embodiments, the storage 1003 is internal to the computing device 1000. In some embodiments, the storage 1003 is external to the computing device 1000. In some embodiments, the storage 1003 is non-volatile, solid-state memory. In some embodiments, the storage 1003 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. The storage 1003 may include one or more memory devices. One or more program modules stored in the storage 1003 may be configured to cause various operations and processes described herein to be executed. While storage is shown as a single element, it should be noted that multiple storage devices of the same or different types may be included in the computing device 1000.

The I/O interface 1004 includes hardware, software, or both providing one or more interfaces for communication between the computing device 1000 and one or more I/O devices. The computing device 1000 may include one or more of these I/O devices, where appropriate. One or more of these I/O devices may enable communication between a person and the computing device 1000. As an example and not by way of limitation, an I/O device may include a keyboard, keypad, microphone, monitor, mouse, speaker, still camera, stylus, tablet, touch screen, trackball, video camera, another suitable I/O device or a combination of two or more of these. An I/O device may include one or more sensors. In some embodiments, the I/O interface 1004 includes one or more device or software drivers enabling the processor(s) 1001 to drive one or more of these I/O devices. The I/O interface 1004 may include one or more I/O interfaces.

The communication interface 1005 includes hardware, software, or both providing one or more interfaces for communication (such as, for example, packet-based communication) between the computing device 1000 and one or more other computing devices or one or more networks. As an example and not by way of limitation, the communication interface 1005 may include a network interface card (NIC) or a network controller for communicating with an Ethernet or other wire-based network or a wireless NIC (WNIC) or wireless adapter for communicating with a wireless network, such as a WI-FI network. This disclosure contemplates any suitable network and any suitable communication interface 1005 for it. As an example and not by way of limitation, the computing device 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing device 1000 may communicate with a wireless PAN (WPAN) (such as, for example, a Bluetooth WPAN or an ultra wideband (UWB) network), a WI-FI network, a WI-MAX network, a cellular telephone network (such as, for example, a Global System for Mobile Communications (GSM) network), or other suitable wireless network or a combination of two or more of these. Additionally the communication interface may provide the functionality associated with short distance communication protocols such as NFC and thus may include an NFC identifier tag and/or an NFC reader able to read an NFC identifier tag positioned with a predetermined distance of the computing device. The computing device 1000 may include any suitable communication interface 1005 for any of these networks, where appropriate. The communication interface 1005 may include one or more communication interfaces 1005.

The bus 1006 interconnects various components of the computing device 1000 thereby enabling the transmission of data and execution of various processes. The bus 1006 may include one or more types of bus structures including a memory bus or memory controller, a peripheral bus, and a local bus using any of a variety of bus architectures.

The above description serves to explain the disclosure; but the invention should not be limited to the examples described above. For example, the order and/or timing of some of the various operations may vary from the examples given above without departing from the scope of the invention. Further by way of example, the type of network and/or computing devices may vary from the examples given above without departing from the scope of the invention. Other variations from the above-recited examples may also exist without departing from the scope of the disclosure.

The scope further includes a non-transitory computer-readable medium storing instructions that, when executed by one or more processors, cause the one or more processors to perform one or more embodiments described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

While the present disclosure has been described with reference to exemplary embodiments, it is to be understood that the invention is not limited to the disclosed exemplary embodiments.

We claim:

1. An information processing method comprising:
obtaining a captured image;
detecting a character region from the captured image;
performing association processing between expense type information specified from each of one or more receipts which are identified by using a detection result of the character region from the captured image and expense amount information specified from each of the one or more receipts in the captured image; and
outputting an expense report obtained based on the association processing between the merchant information of each of one or more receipts and the one or more pieces of expense amount information of each of the one or more receipts.

2. The method according to claim 1, wherein the character region is detected by OCR (Optical Character Recognition) processing.

3. The method according to claim 1, wherein the character region is detected based on a region designation operation by a user.

4. The method according to claim 1, wherein the each of the one or more receipts are identified based on a position of each of character regions in the captured image.

5. The method according to claim 1, wherein the each of the one or more receipts are identified based on a type of each of character regions in the captured image.

6. The method according to claim 5, wherein the type contains at least one of a merchant name, a merchant address, a merchant phone number, an expense amount, and an amount name regarding an expense item.

7. The method according to claim 5, the each of the one or more receipts are identified by using spatial region information that is obtained by expanding the each of the character regions according to their type.

8. The method according to claim 7, wherein the each of the character regions is expanded in a predefined direction according to the type.

9. The method according to claim 7, wherein the each of the character regions is expanded by a predefined amount according to the type.

10. The method according to claim 9, wherein the predefined amount is proportional to an average value of a height of the character region.

11. The method according to claim 1, wherein if a distance between character strings is longer than a predetermined threshold, the character strings are determined as character strings which are belonging to a different receipt.

10. The method according to claim 1, wherein the expense report is output to at least one of a display device, a storage device, and a printing device.

13. An information processing apparatus comprising:
a hardware processor; and
a memory storing one or more instructions configured to be executed by the hardware processor, the instructions causing the apparatus to perform operations including:
obtaining a captured image;
detecting a character region from the captured image;
performing association processing between expense type information specified from each of one or more receipts which are identified by using a detection result of the character region from the captured image and expense amount information specified from each of the one or more receipts in the captured image; and
outputting an expense report based on the association processing between the expense type information specified from each of one or more receipts and the expense amount information specified from each of the one or more receipts.

14. The apparatus according to claim 13, wherein the each of the one or more receipts are identified based on a position of each of character regions in the captured image.

15. The apparatus according to claim 13, wherein the each of the one or more receipts are identified based on a type of each of character regions in the captured image.

16. An information processing method comprising:
obtaining a captured image;
detecting an object from the captured image;
specifying a receipt region by using a detection result of the object;
performing association processing between expense type information that is specified from the receipt region that is identified based on the detection result of the object and expense amount information that is specified from the receipt region; and
outputting an expense report obtained based on the association processing between the expense type that is specified from the receipt region in the captured image and the expense amount information that is specified from the receipt region in the captured image.

17. The method according to claim 16, wherein the object is a line segment.

18. The method according to claim 17, wherein the object is a rectangle object.

19. The method according to claim 17, wherein the receipt region is identified based on a size of the object in the captured image.

20. The method according to claim 19, wherein the receipt region is identified based on a paper size that is estimated based on the size of the object in the captured image.

21. The method according to claim 17, wherein the receipt region is identified based on a position of the object in the captured image.

22. The method according to claim 21, wherein a region of a predetermined range from the position of the object in the captured image is identified as the receipt region.

23. The method according to claim 17, wherein the expense report is output to at least one of a display device, a storage device, and a printing device.

24. An information processing apparatus comprising:
a hardware processor; and
a memory storing one or more instructions configured to be executed by the hardware processor, the instructions causing the apparatus to perform operations including:
obtaining a captured image;
detecting an object from the captured image;
specifying a receipt region by using a detection result of the object;
performing association processing between expense type information that is specified from the receipt region that is identified based on the detection result of the object and expense amount information that is specified from the receipt region; and
outputting an expense report obtained based on the association processing between the expense type information that is specified from the receipt region in the captured image and the expense amount information that is specified from the receipt region in the captured image.

25. The apparatus according to claim 24, wherein the receipt region is identified based on a size of the object in the captured image.

26. The apparatus according to claim 25, wherein the receipt region is identified based on a paper size that is estimated based on the size of the object in the captured image.
